(19) United States
(12) Patent Application Publication
(10) Pub. No.: US 2021/0197345 A1
(43) Pub. Date: Jul. 1, 2021

(54) HOLLOW SHANK POWER NUT DRIVERS

(71) Applicant: Richard LeVert, Victoria (CA)

(72) Inventor: Richard LeVert, Victoria (CA)

(21) Appl. No.: 17/203,717

(22) Filed: Mar. 16, 2021

Related U.S. Application Data
(63) Continuation of application No. 12/804,693, filed on Jul. 27, 2010, now abandoned.
(60) Provisional application No. 61/271,927, filed on Jul. 28, 2009.

(30) Foreign Application Priority Data
Jul. 28, 2010 (CA) 2711315

(51) Int. Cl. B25B 13/06; B25B 15/00; B25B 23/00; B25B 13/48

(52) U.S. Cl. CPC B25B 13/06; B25B 13/48; B25B 23/0035; B25B 15/001

(57) ABSTRACT

A hollow shank power nut driver axially drives nuts over uninterrupted elongated threaded rods. The hollow shank permits the nut to be driven down a long threaded rod to the limit of this shank. This hollow shank is of sufficient diameter to accommodate the threaded shaft that fits the socket.

### RELATED APPLICATIONS

This application is a continuation of application Ser. No. 12/804,693, filed Jul. 27, 2010 (the '693 application). Applicant claims priority from the '693 application pursuant to 35 U.S.C. § 120. The '693 application is based upon provisional patent application Ser. No. 61/271,927 filed on Jul. 28, 2009, and claims priority therefrom pursuant to 28 U.S. Code § 119(e).

### FIELD OF THE INVENTION

The present invention relates to a hollow shank power nut driver which can axially drive nuts over elongated threaded rods.

### BACKGROUND OF THE INVENTION

The commercial electrical industry, plumbing, HVAC, sprinkler fitters, industrial contractors, and even carpenters use millions of feet of ⅜″ threaded rod also known as “redi rod” on a daily basis. This is in addition to the very common nuts and bolts of the ⅜″-16 coarse thread variety; there is a need to install and fasten this hardware sometimes driving the nut far from the end of a threaded rod. The required socket wrench for a ⅜″ SAE nut or bolt is 9/16″ size.

Most tradesmen have in their tool boxes socket sets and wrenches that include this size. This type of tool is typically kept in a truck tool box or in lock boxes sometimes found at job sites. More commonly, the tradesman is reduced to using a crescent wrench or even water pump pliers because these are more commonly carried and of a universal fit that makes them more useful to pack than full socket sets.

The common denominator is that these tools are all hand driven/operated. With the advent of cordless battery powered drills, many ‘hand jobs’ have become motorized or powered, vastly increasing the speed of the installation and reducing fatigue and repetitive operation injuries such as carpal tunnel syndrome.

The use of powered drills has not transferred over to the very common ⅜″ nut and bolt.

Although there are commonly available ‘sockets’, sometimes called Nut Setters, with a collet drive shank, the largest size is ½″. Many of these Nut Setters have magnets in the bottom of the socket to hold the fastener; they are not hollow shank.

There is a collet chuck to square socket drive adapter which permits the use of sockets including the 9/16″ size, but they are not in common use. One of the limitations of these adapters and sockets is that they tend to come apart, and the components get lost. An even bigger limitation is that even with the use of deep sockets, the maximum depth or reach is around 2″.

There is a tool that has a hollow shank which is in common usage. These tools are called Nut Drivers. They are available in 9/16″ size, but they are only hand operated. Furthermore, although they typically have a 4″ shank, the shank is hollow only for about 2″. This hollow shaft depth is not sufficient for use with ⅜″ “redi rod”. A typical hand driven nut driver with a partially hollow shank is described in pending US Patent application publication number 2008/0196562 of Elliston et al. A similar hand held partially hollow shank nut driver tool is sold by Klein Tools of Chicago, Ill.

U.S. Pat. No. 5,615,587 of Foerster describes a tool with a hollow shank but not a true socket on the driven end. It is a friction fit driven tool with inherent torque limiting capability, or slip function.

U.S. Pat. No. 5,782,148 of Kerkhoven describes a dual depth tool with a socket designed to deliver torque with a shallow socket to apply pressure to start a nut or bolt engagement. The shallow socket limits the travel of the socket to protect delicate work surfaces.

U.S. Pat. No. 3,837,244 of Schera, Jr. describes a socket wrench with a hollow shank having fluted and radially extending spring fingers to grip fasteners. The purpose of the hollow shank is to enable the slits to create the fluted and radially extending finger springs.

U.S. Pat. No. 4,307,634 of Gentry describes a nut driver with a hollow shank to accommodate the storage of a plurality of concentrically aligned hexagonal sockets of smaller sizes.

The prior art tools available are not as well suited to the uses described as the hollow shank power nut driver of this invention.

### SUMMARY OF THE INVENTION

The hollow shank power nut drivers of this invention have a long hollow shank, a socket of the appropriate size with a hollow center at the distal end and a collet drive shank at the proximal end. The internal diameter of the hollow shank is sized to provide clearance for a threaded rod of the size to be serviced by the socket at the distal end with a clearance hole to accommodate the same threaded rod. Although provided in a variety of lengths commensurate with the application in a specific industry or application, they are one-part devices with no attachments to fall off and get lost. They can power drive a nut far up on the end of a threaded rod using a battery powered drill driver. The 9/16″ socket needed for use with ⅜″ ‘redi rod’ is of course accommodated, although other sizes can be manufactured for different sizes of threaded rod. These hollow shank power nut drivers can also be used for any task typically handled by a deep socket drive of the same size. Handles that fit the collet drive shank can be used to drive the hollow shank power nut drivers manually if desired; these are commonly available.

In an alternate embodiment, a hollow shank is used with a variety of removable sockets to handle jobs where different sizes of fasteners or threaded rod are commonly used. Removable different sized sockets with a standard top collar having a hollow center and a hexagonal (or square) female recess are used. The distal end of the hollow shank is formed into a hexagon (or square) crossection. In this embodiment the hollow shank is sized with an ID to accommodate the largest sized threaded rod to be serviced by the sockets of a given “family”. All smaller sockets with the standard collar that fits over the formed distal end of the hollow shank will of course be insured that any smaller threaded rod would also fit.

These removable sockets are retained over the shank distal end by spring clips which engage a groove near the top end of the collar of each socket. In another engagement variation, two or more balls engage the same groove under spring force by a spring band fitted over a formed circular collar forming an annular space into which the collar of each socket would fit. The retention collar is attached to the hollow shank near the distal end and forms the annular space facing toward the distal end. The formed end of the hollow shank (preferably a hexagonal crossection) engages the socket collar to transmit the torque driving the nut or fastener head.

The size aspect is applicable to other size versions of the threaded rods having the nuts applied thereto, up a to a full range of lengths beyond what is stated herein as examples. Also, the diameter of the rods is variable, including other embodiments, such as, for example, using standard 5/16″ or ⅜″ hex nuts.

The hollow shank power nut driver of the present invention also has construction situations as a primary field of utilization as opposed to conventional sockets that tend to be ‘automotive’ in nature. Conventional sockets are most often used to drive a bolt head and or when the nut is driven, the bolt or stud is tailored to not protrude excessively, usually for esthetic reasons. In construction, long studs such as a thread rod are a design necessity. When long studs are used, there is a need to thread the nuts much farther.

The long reach of the present invention is also useful for accessing tight locations where wrenches and hands can't go. Conventional wisdom has been to deal with these situations with a variety of long add on extensions and conventional sockets, but the nut travel is limited to max 3″. The present invention has no such limitations.

Additionally, the hollow shank power nut driver of the present invention is preferably a one piece tool so no parts such as extensions come off and go missing. This may not be a big problem in a nice tidy repair shop but it certainly is if a user is working in the mud or sand of a construction site, or up on a scaffolding, ladder or on the 40th floor of a new high rise.

In contrast to Kerkhoven '148, the present invention has a single, shallow socket head but with a deep hollow shank.

In contrast to Foerster '387, the hollow shank power nut driver of the present invention is designed to deliver full torque to the nut. The present invention can drive lag bolts, and can employ larger drive shanks but the collet drive is fast to use, commonly used and inherently traps the tool so it does not slip off, all without the need to tighten a conventional chuck.

The present invention can optionally be driven by hand by a multitude of common hand drivers that employ a collet drive.

In automotive use, the present invention is useful for hard to access parking brake cable adjusters and specialized wheel nut sockets for aluminum wheels. Large versions can be used in carpentry and construction for larger versions (¾″ and 15/16″). These would be used for fastening “J bolts” (anchor bolts) that hold framing base plates to the concrete footings. Essentially, these tools would be used ‘upside’ down as opposed to the 9/16″ which often is used overhead on rods protruding from the ceiling. This application of the present invention permits the contractor to easier set the anchor bolts in the concrete. More thread can be exposed since the shank accommodates it and they are not fastening the nuts with a crescent or hand wrench. The present invention allows the user to optionally work from a standing position because the length of the tool can be tailored to this.

In summary, the hollow shank power nut driver of the present invention has a long reach for tight places, a hollow shank for long rods, a shallow socket for ease of starting, delivers full torque and fits high speed collet drive tools (plus hand drivers).

### BRIEF DESCRIPTION OF THE DRAWINGS

The present invention can best be understood in connection with the accompanying drawings. It is noted that the invention is not limited to the precise embodiments shown in drawings, in which:

FIG. 1 is a side elevation view of a power drill driver engaged with a power drive hollow shank nut driver of this invention.

FIG. 2 is a side elevation view of nut driver of this invention with the hollow shank and drive socket at the distal end shown in crossection to reveal the end of a threaded rod within.

FIG. 3 is a side elevation view of a family of three nut drivers of this invention of the same diameter but with three different lengths.

FIG. 4 is a dimensioned side elevation view of a medium length hollow shank power nut driver.

FIG. 5 is a dimensioned end view of ono example of the nut driver of FIG. 4.

FIG. 6 is a perspective view of an alternate embodiment hollow shank power nut driver using interchangeable sockets with spring clip retention.

FIG. 7 is a set of side, top, and bottom elevations of a large socket and a small socket using the same top engagement collar.

FIG. 8 is a side elevation of an end detail in partial crossection showing an alternate socket retention mechanism using metal balls for socket retention.

FIG. 9 is a perspective view of a spring collar and two balls used in the method of FIG. 8.

FIGS. 10A and 10B are side and front views of an embodiment with a ¾ inch socket on a hollow shank, showing a ¾ inch hex shank adaptable to a power driver.

FIG. 11 is a side elevation view of a hollow shank power nut driver with a ¾ inch socket, hollow shank and ¼ inch removable collet to socket adapter.

FIGS. 12A, 12B, 13A, 13B, 14A, 14B, 15A and 15B are side and front elevation views of alternate embodiments for hollow shank power nut drivers.

FIG. 16 is an exploded perspective showing use of the hollow shank power nut driver of the present invention in use at a construction site with a 2″×6″ wood frame plate board attached to a typical concrete footing by a J-bolt embedded within the concrete footing.

FIG. 17 is a side elevation view of a 15/16 inch socket with an adapter for a ¾ inch tool, with a center bored out to 0.65 inch, to accommodate a rod.

### DETAILED DESCRIPTION OF THE INVENTION

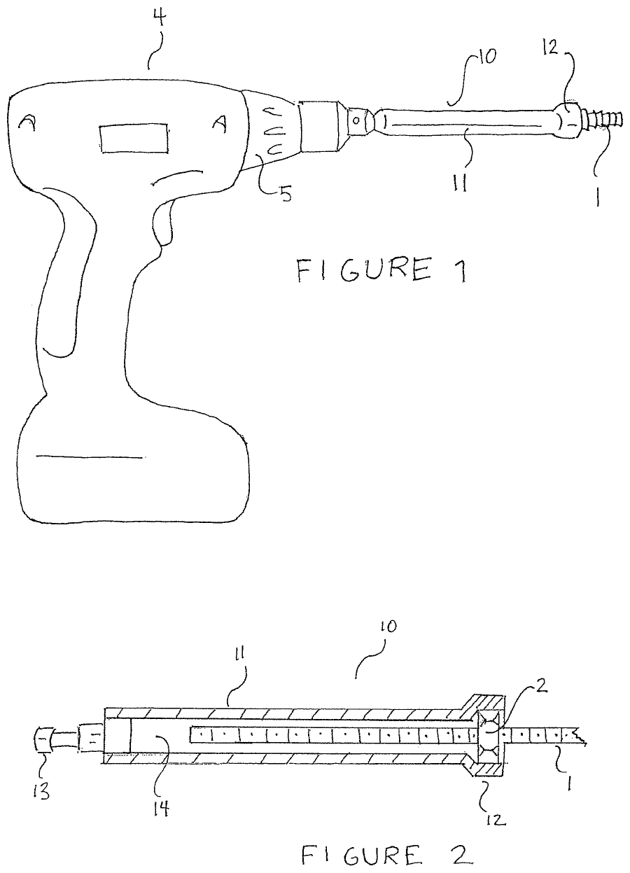

FIG. 1 shows power drill driver 4 with hollow shaft nut driver 10 of this invention engaged in chuck 5. Hollow shaft 11 with integral socket 12 and threaded rod 1 are also illustrated. As shown in FIGS. 1 and 2, the power driven hollow shank nut driver 10 includes an elongated hollow shaft 11 having proximate and distal ends; a socket 12 mounted on the distal end of the hollow shaft 11, wherein a nut 2 is seated in the socket 12. The extended threaded rod 1 the hollow shaft 11 extends out of the hollow shaft through the nut 2. A proximal end of the extended rod 1, when located within the hollow shaft 11, is spaced apart from the proximal end of the hollow shaft 11. For use, a drive shank 13 is mounted on the proximal end of the hollow shaft 11; and is driven by a powered source of drive for the drive shank. The nut driver 10's powered source can be chuck 5 engaged with the drive shank, wherein further a power drill driver engages with the chuck 5.

FIG. 2 also shows the collet drive shank 13 attached to the top end of the hollow shaft 11 with empty space 14 in front of threaded rod 1's free end. Nut 2 is shown engaged within socket 12.

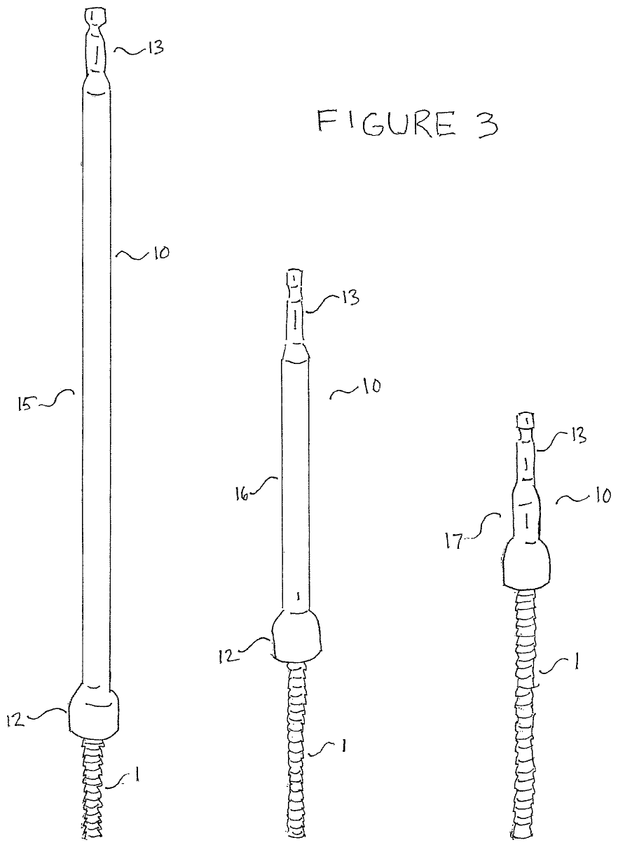

FIG. 3 shows a family of three hollow shank nut drivers 10 of different lengths from longest 15 to midsize 16 to shortest 17. Generally, as shown in FIG. 3, the hollow shaft can be one of a set of any number of hollow shafts of different lengths.

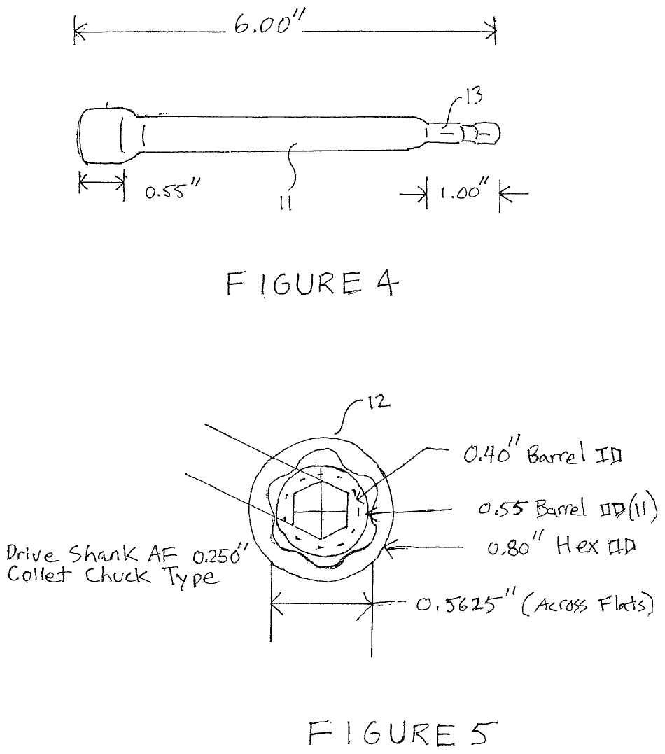

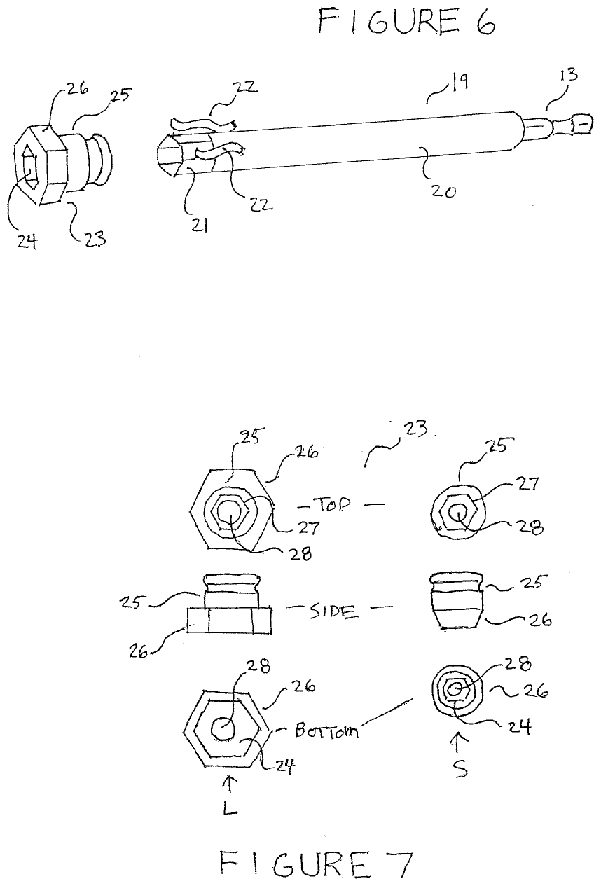

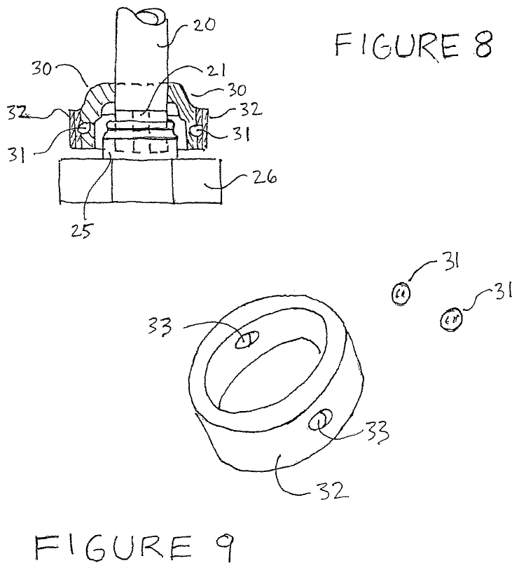

FIG. 4 is a dimensioned side elevation of a midsized hollow shank nut driver for a typical ⅜″ ‘redi rod’ using a 9/16″ sized socket.

The dimensioned top end view is shown in FIG. 5.

FIGS. 6-9 detail an alternate embodiment 19 of power driven hollow shaft nut drivers using interchangeable sockets to accommodate different sizes of threaded rod or fasteners.

For example, the nut driver's socket 12 can optionally be integral with the distal end of the hollow shaft.

In FIG. 6, hollow shank 20 is formed into a hexagon 21 at its distal end. Socket 23 has a top collar 25 with a recess which fits over end 21. Socket section 26 accommodates a nut or fastener head which fits open end 24. Groove near the top edge of standard collar 25 retains socket 23 onto shank 20 by the action of three spring clips 22 distributed around distal end 21.

FIG. 7 contrasts side, top, and bottom views of two different sized sockets 23 from the same family having a common style and sized top collar 25. Note the large through hole 28 at the center of the larger socket on the left. The smaller socket on the right has a smaller bottom hex opening 24 to accommodate a smaller nut or fastener head. Even though the top collar 25 is the same, and the hex top recess is the same as for the larger socket, the through hole in the center 28 is necessarily smaller, however it still provides clearance for the compatible threaded rod.

FIGS. 6 and 7 also show that the socket can include a collar removably mounted on the distal end of the hollow shaft. There can also be a socket shaped recess 21 which is formed in the collar, so that the nut is seated in the socket shaped recess. The collar can optionally be interchangeable with at least one other collar having a differently size socket shaped recess for accommodating a differently size nut.

Also, optionally the distal end of the hollow shaft can have spring clips for retaining the collar on the distal end of the hollow shaft, as shown in FIG. 6.

FIG. 8 is a side view detail of an alternate socket retention method using shank 20 attached collar 30 which forms an annular space sized to accept the OD of collar 25. Two balls 31 are shown forced within the top collar groove by outer spring band 32. Therefore, FIG. 8 shows the attaching member collar 30 mounted on the distal end of the hollow shaft, wherein there is formed an annular space to receive the collar, with the spring mounted ball bearings being employed to hold the collar in place on the hollow shaft.

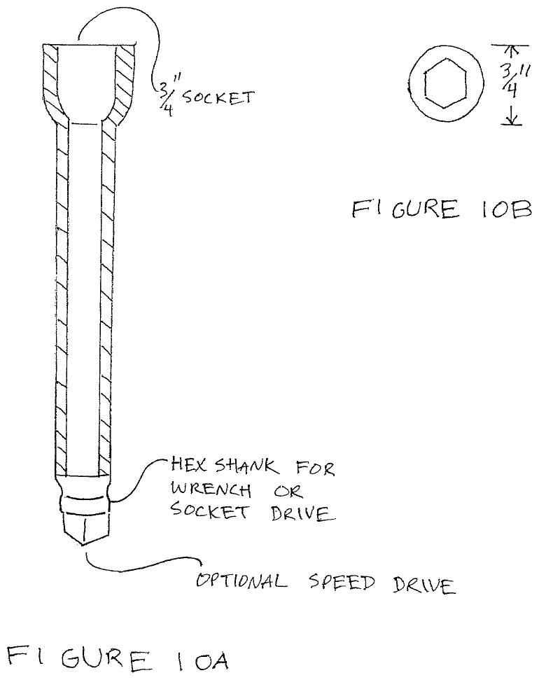

FIG. 9 shows a better view of spring band 32 with locating holes 33 for balls 31.

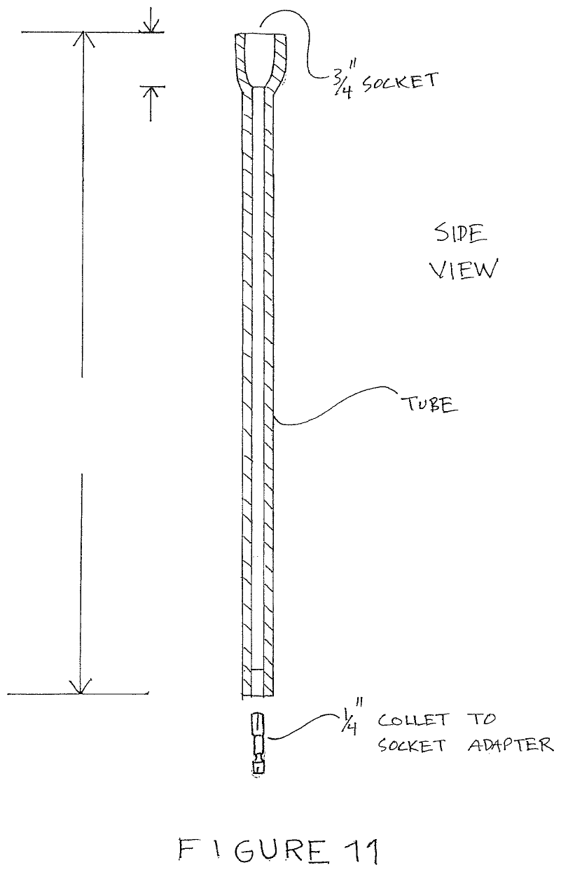

FIGS. 10A and 10B are side and front views of an embodiment with a ¾ inch socket on a hollow shank, showing a ¾ inch hex shank adaptable to a power driver. In FIG. 10A, the ‘external’ ¾″ hex drive is on the drive end of the shank. This feature allows the tradesman to use another wrench or socket to drive the hollow shank power nut driver of the present invention via a ‘crescent wrench, an open or hex end wrench, a socket and ratchet or even water pump pliers or a pipe wrench. The latter two are sometimes all a tradesman has. This type of drive might be necessary because the drill battery had gone dead or the drill was too small to apply sufficient torque for these larger applications. This model of the hollow shank power nut driver could even be driven by another ¾″ hollow shank power nut driver. It would permit a tradesman to stack them, so to speak, and create a very long tool to reach into tight places or possibly high over head. It adds an extra measure of versatility.

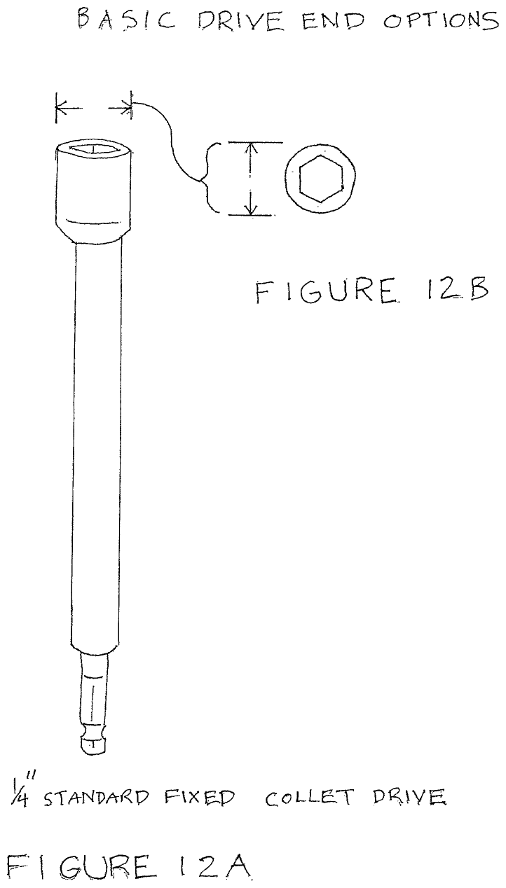

FIG. 11 is a side elevation view of a hollow shank power nut driver with a ¾ inch socket, hollow shank and ¼ inch removable collet to socket adapter.

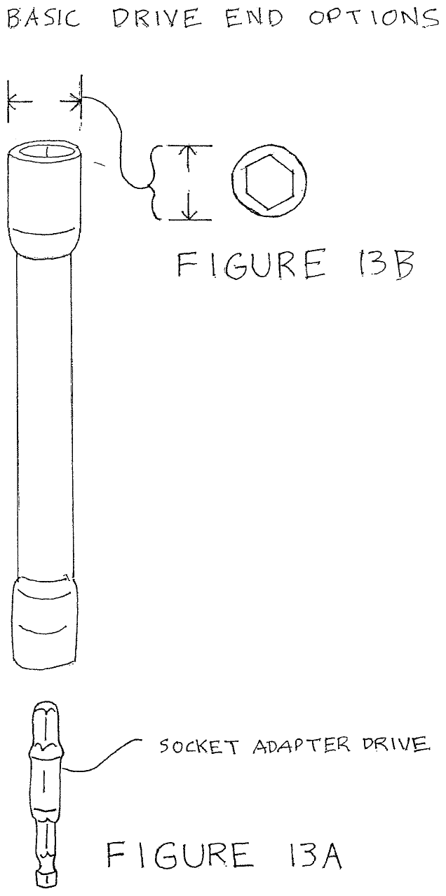

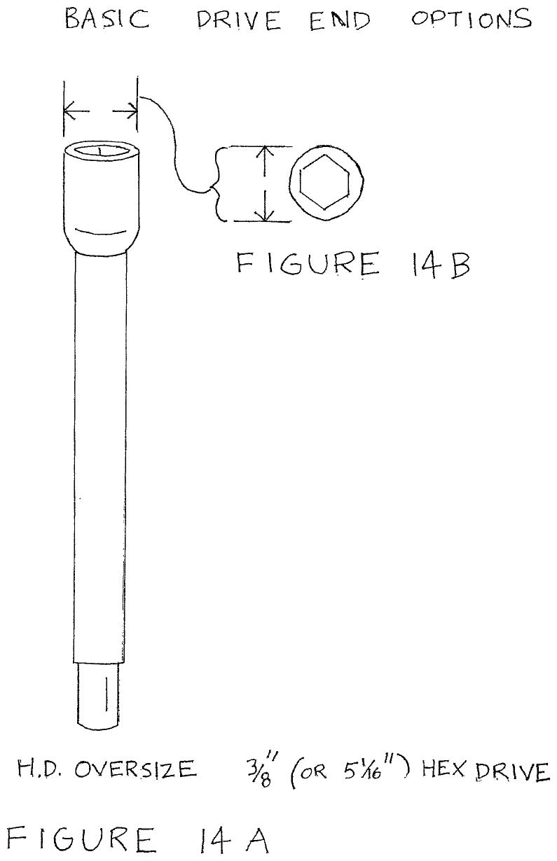

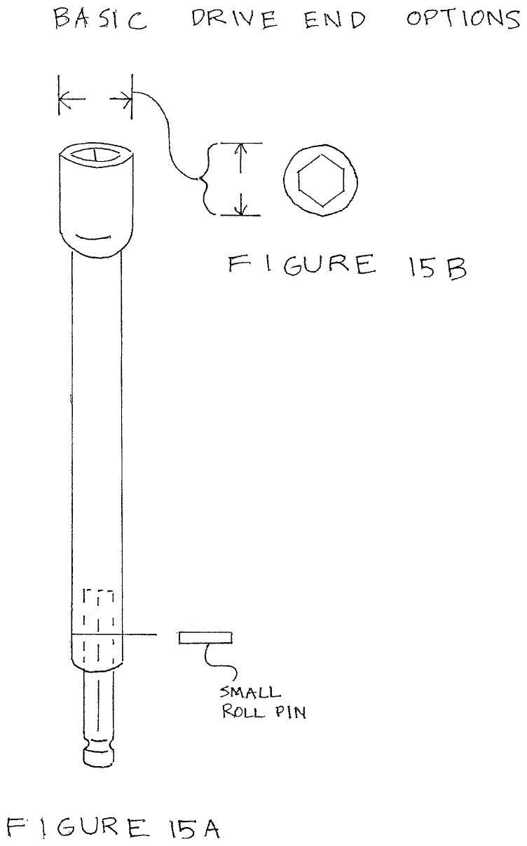

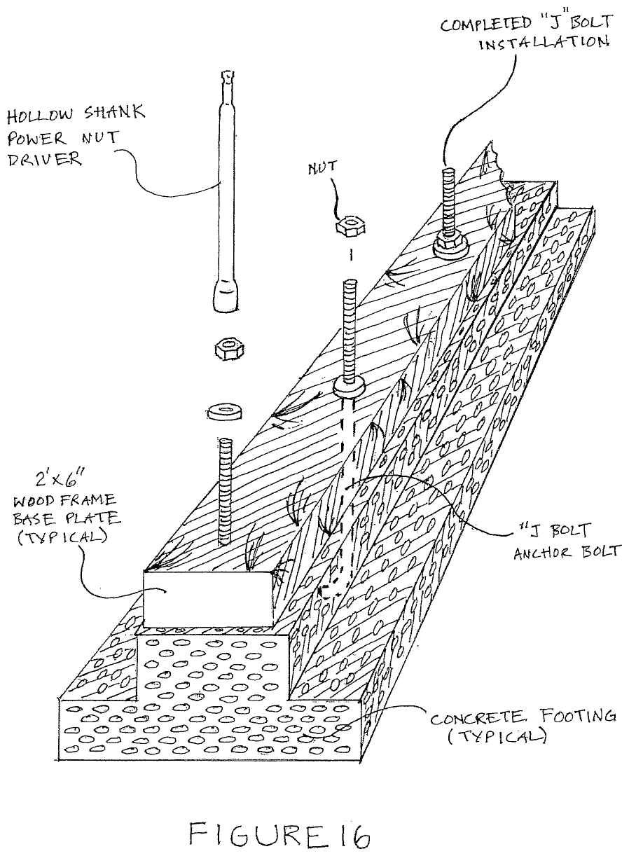

FIGS. 12A, 12B, 13A, 13B, 14A, 14B, 15A and 15B are side and front elevation views of alternate embodiments for hollow shank power nut drivers. In FIG. 12A a ¼ inch collet drive is integrally attached to the hollow shank. In FIG. 13A the socket adapter drive is insertably removable to and from the hollow shank. In FIG. 14A a ⅜ inch hex drive is provided integral with the hollow shank. In FIG. 15A a removable replaceable ¼ inch drive is held in place by a small roll pin.

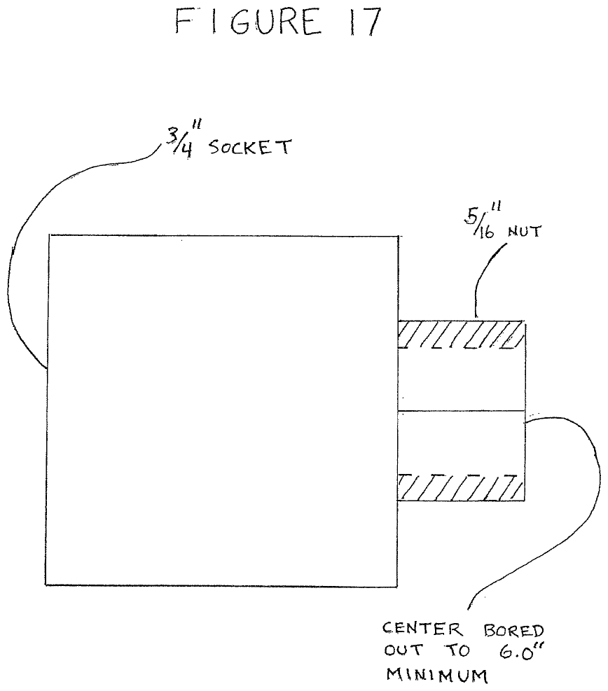

FIG. 16 is an exploded perspective showing use of the hollow shank power nut driver of the present invention in use at a construction site with a single 2″×6″ wood frame plate board attached to a typical concrete footing by a J-bolt embedded within the concrete footing. FIG. 16 illustrates the bottom wood sill plate that is typical in a wood frame construction application where the framing is bolted down to the concrete foundation. The bottom wood frame base plate is normally one 2×6 thick. The concrete footing is typically an inverted T-shape in crossection, with the smaller upwardly extending portion dimensioned to accept and support the 2″×6″ wood frame plate board. Large versions can be used in carpentry and construction for larger versions (¾″ and 15/16″). These would be used for fastening “J bolts” (anchor bolts) that hold framing base plates to the concrete footings. Essentially, these tools would be used ‘upside’ down as opposed to the 9/16″ which often is used overhead on rods protruding from the ceiling. For example, FIG. 16 shows a distal end of the hollow shaft being embedded in a construction member for engaging the threaded rod, and the threaded rod is attachable at a distal end thereof to a footing within the construction member. This application of the present invention permits the contractor to easier set the anchor bolts in the concrete. More thread can be exposed since the shank accommodates it and they are not fastening the nuts with a crescent or hand wrench.

FIG. 17 is a side elevation view of a ¾ inch socket with an adapter for a 15/16 inch tool and nut, with a center bored out to 0.650 inch, to accommodate a rod. This hollow shank power nut driver may have a replaceable drive mechanism, a “flat” near the drive end to accommodate a crescent wrench, optional magnet, and an adapter for multiple nut size capability. It is repairable and is subject to much higher torque loads than other versions.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention.

I claim:

1. A method of bolting down framing on a concrete foundation of a building consisting essentially of the steps of:
in a construction site, providing a concrete footing with a distal end of a threaded J-bolt embedded therein and a wood frame base plate mounted on said concrete footing through which said threaded J-bolt passes upwardly therethrough;
selecting a driver from a set of drivers each comprising an uninterrupted elongated hollow shaft of a different length with a closed proximate end with a long reach for accessing tight locations where said threaded J-bolt leaves said wood frame base plate and where wrenches and hands can't go,
said uninterrupted elongated hollow shaft being in excess of three inches in length;
selecting said selected driver having an enlarged hollow drive shank mounted on and integral with said closed proximate end having a permanently built-in axially aligned integral collet drive adapter associated therewith, said selected driver further having an open distal end and a hollow one piece socket integrally mounted on said open distal end of each said hollow shaft, of said selected driver; said selected driver having a smooth, continuous, uninterrupted portion between said collet drive adapter at said closed proximate end and said hollow one piece socket integrally mounted thereon; said selected driver selected for having a length sufficient to completely enclose said J-bolt extending out of said base plate, said driver in effect comprising a one part device with no attachments to fall off;
selecting and seating a single nut in said socket and engaging said threaded J-bolt from a free end thereof and threading said nut for a full length of said J-bolt where long thread rods are a design necessity down to where said nut is tightened on said base plate, whereby there being no limitation on nut travel;
wherein said hollow shaft is adapted to receive therewithin said extended J-bolt, and wherein said J-bolt extends into said hollow shaft and through said single nut, said J-bolt threadable through said single nut along a length thereof, and wherein a proximal end of said extended J-bolt within said hollow shaft is spaced apart from said closed proximal end of said hollow shaft; and
in a single tightening step, using a power tool adaptable to said collet drive adapter, driving said drive shank to deliver full applied torque with no slippage through said hollow one piece integrally mounted socket at said distal end to said single nut; and tightening down said single nut on said threaded J-bolt in said single tightening step without stopping to separately tighten any other further nut to said threaded J-bolt.

2. A method of bolting down framing on a concrete foundation of a building comprising the steps of:
in a construction site, providing a concrete footing with a curved end of a threaded J-bolt embedded therein and extending upwardly through a wood frame base plate mounted on said concrete footing and having a free length above said base plate terminating in a free end above said base plate, said J-bolt threaded up to said free end;
selecting a driver comprising an uninterrupted elongated hollow shaft of sufficient length to fully enclose said length of said J-bolt, said driver having a closed proximate end with a drive shank mounted on and integral with said closed proximate end, said drive shank having a permanently built-in axially aligned integral collet drive adapter associated therewith and an open distal end with a hollow one piece socket integrally mounted on said open distal end;
said selected driver having a smooth, continuous, uninterrupted portion between said drive shank at said closed proximate end and said hollow one piece socket integrally mounted thereon;
said uninterrupted elongated hollow shaft being in excess of three inches in length;
selecting a nut to engage said threaded J-bolt;
seating said nut in said socket;
wherein said hollow shaft is adapted to receive therewithin said extended J-bolt, and wherein said J-bolt extends into said hollow shaft and through said single nut, said J-bolt threadable through said single nut along a length thereof, and wherein a proximal end of said extended J-bolt within said hollow shaft is spaced apart from said closed proximal end of said hollow shaft, whereby there being no limit on nut travel;
in a single tightening step, using a power tool adaptable to said collet drive adapter, driving said drive shank to deliver full applied torque with no slippage through said hollow one piece integrally mounted socket at said distal end to said single nut; and tightening down said single nut on said threaded J-bolt in said single tightening step without stopping to separately tighten any other further nut to said threaded J-bolt; and,
using said driver to thread said nut on said free end of said J-bolt over the full free length thereof where long thread rods are a design necessity all the way down to said base plate and tightening said nut on said J-bolt against said base plate.

3. The method of claim 2 in which a power tool is used to engage said drive shank to deliver full applied torque with no slippage through said hollow one piece integrally mounted socket to said nut, said power tool having a chuck engaged with said collet drive adapter.

4. The method of claim 3 in which said driver is selected from a set of drivers of differing lengths to match any free length of a J-bolt to be tightened in place.

5. A method of bolting down a nut upon a threaded rod comprising the steps of: providing a threaded rod extending outwardly from a base surface and having a free length above said base surface and terminating in a free end above said base surface,
selecting a driver comprising an uninterrupted elongated hollow shaft of sufficient length to fully enclose said length of said threaded rod, said driver having a closed proximate end with a drive shank mounted on and integral with said closed proximate end, said drive shank having a permanently built-in axially aligned integral collet drive adapter associated therewith and an open distal end with a hollow one piece socket integrally mounted on said open distal end;
said uninterrupted elongated hollow shaft being in excess of three inches in length;
said selected driver having a smooth, continuous, uninterrupted portion between said drive shank at said closed proximate end and said hollow one piece socket integrally mounted thereon;
selecting a nut to engage said threaded rod;
seating said nut in said socket;
wherein said hollow shaft is adapted to receive therewithin said extended threaded rod, and wherein said threaded rod extends into said hollow shaft and through said single nut, said threaded rod threadable through said single nut along a length thereof, and wherein a proximal end of said extended threaded rod within said hollow shaft is spaced apart from said closed proximal end of said hollow shaft, whereby there being no limit on nut travel;
further wherein a power tool is used to engage said drive shank to deliver full applied torque with no slippage through said hollow one piece integrally mounted socket to said nut, said power tool having a chuck engaged with said drive shank,
in a single tightening step, using said power tool adaptable to said collet drive adapter, driving said drive shank to deliver full applied torque with no slippage through said hollow one piece integrally mounted socket at said distal end to said single nut; and tightening down said single nut on said threaded rod in said single tightening step without stopping to separately tighten any other further nut to said threaded rod; and,
using said driver to thread said nut on said free end of said threaded rod over the full free length thereof where long thread rods are a design necessity all the way down to said base surface and tightening said nut on said threaded rod against said base surface.

6. The method of claim 5 in which said driver is selected from a set of drivers of differing lengths to match any free length of a threaded rod.
